(19) United States
(12) Patent Application Publication
(10) Pub. No.: US 2011/0140323 A1
(43) Pub. Date: Jun. 16, 2011

(54) AIR SUSPENSION

(76) Inventor: Byung Soo KWON, Gyeonggi-do (KR)

(21) Appl. No.: 12/876,546

(22) Filed: Sep. 7, 2010

(30) Foreign Application Priority Data
Sep. 7, 2009 (KR) 10-2009-0083948

(51) Int. Cl. B60G 15/12; F16F 9/04

(52) U.S. Cl. 267/64.24

(57) ABSTRACT

Disclosed is an improved air suspension that prevents damage and/or failure of a component of an air spring, such as an air sleeve, by unwanted force or moment, such as rotational torque, applied to the air spring during vehicle traveling. The air suspension includes a damper including a cylinder and a piston rod, an air spring to which a canister and an air piston are hermetically connected via an air sleeve, an upper mount which secures the piston rod and the canister to a vehicle frame, a first bearing disposed at a connecting portion between the upper mount and the piston rod, and a second bearing disposed at a connecting portion between the air piston and the cylinder. Each of the first and second bearings is a thrust bearing.

### BACKGROUND

1. Technical Field

The present disclosure relates to an air suspension including a damper and an air spring, and, more particularly, to an air suspension which includes an improved structure to prevent damage of a component of an air spring, in particular, an air sleeve.

2. Description of the Related Art

In general, a suspension is disposed between a vehicle frame and wheels, and includes springs and dampers, that is, shock absorbers. The suspension using air springs as the springs is referred to as an “air suspension”. The air suspension includes an upper mount for securing both the damper and air spring to the vehicle frame.

The damper includes a cylinder and a piston rod. The cylinder has a space filled with an operating fluid, such as an oil, inside a tube. A piston valve is disposed in the tube to generate damping force in cooperation with the operating fluid. Since the piston valve is connected to a piston rod, the piston valve generates the damping force in cooperation with the operating fluid by relative movement between the cylinder and the piston rod.

The air spring includes a canister, an air piston, and an air sleeve. The canister is hermetically joined to the air piston by the air sleeve made of a flexible material. Accordingly, the air piston and the canister can move relative to each other, and the air sleeve is resiliently operated with respect to relative movement between the air piston and the canister by compressed air in the air spring. Generally, the upper mount secures the piston rod of the damper and the canister of the air spring to a vehicle frame side. Here, the air piston of the air spring is secured to a lower portion of the damper.

Conventionally, the air suspension has a problem in that components of the air spring, in particular, an air sleeve and/or an air tube, are highly susceptible to damage due to up-down movement, torsional rotation and an upward tilted angle (that is, coning angle) applied to the air spring during steering of the vehicle. This problem is common to both a canister insert-molding integration type and a canister/upper mount separation type. In the former case, for example, when steering a 5-link double wishbone type vehicle, the variation in kingpin axis causes the up-down movement, torsional rotation and coning angle in the air spring, so that cracks are formed on a damper bush and the air sleeve is damaged. In the latter case, when steering the 5-link double wishbone type vehicle, the variation in kingpin axis causes the up-down movement, torsional rotation and coning angle in the air spring, so that torsional moment is generated between the upper mount and the canister, thereby damaging the air tube.

### BRIEF SUMMARY

The present disclosure is directed to solving the problems of the related art, and an aspect of the present disclosure provides an improved air suspension that prevents damage and/or failure of components of an air spring, such as an air sleeve, by unwanted force or moment, such as rotational torque, applied to the air spring during vehicle traveling.

In accordance with an aspect of the present disclosure, an air suspension includes: a damper including a cylinder and a piston rod; an air spring to which a canister and an air piston are air-tightly connected via an air sleeve; an upper mount which secures the piston rod and the canister to a vehicle frame; a first bearing disposed at a connecting portion between the upper mount and the piston rod; and a second bearing disposed at a connecting portion between the air piston and the cylinder.

Each of the first and second bearings may be a thrust bearing. The first and second bearings, in particular, the first and second bearings employing the thrust bearings, may permit rotational movement of a damper side to counterbalance rotational moment of a kingpin axis, thereby preventing damage and/or failure of the air sleeve and/or an air tube.

The air suspension may further include a piston guide between the air piston and the cylinder. The piston guide may be made of a viscoelastic material, for example, urethane, and may serve to reduce a coning angle between the air piston and the cylinder.

In one embodiment, the first bearing is disposed on the piston rod between a rod holder at a side of the upper mount and the piston rod. Furthermore, the first bearing is supported at one end thereof by a step of the piston rod and supported at the other end thereof by a fastening portion fastened to the piston rod. Herein, the term “fastening portion” means a component to be fastened to the piston rod, and may include, for example, a nut.

In another embodiment, the second bearing is disposed between an upper surface of an outer diameter-expansion portion of the cylinder and a lower surface of an inner diameter-expansion portion of the air piston.

In accordance with an aspect of the present disclosure, an air suspension for a 5-link double wishbone type vehicle with a kingpin axis includes: a damper including a cylinder and a piston rod; an air spring an comprising air piston; an upper mount which secures the damper and the air spring to a vehicle frame; and counterbalancing means disposed between the upper mount and the air spring or the damper for counterbalancing rotational moment of the kingpin axis.

Said counterbalancing means may comprise a first thrust bearing disposed at a connecting portion between the air piston and the cylinder and/or a second thrust bearing disposed at a connecting portion between the upper mount and the piston rod.

In one embodiment, the air suspension may comprise a piston guide formed between the air piston and the cylinder to reduce a coning angle therebetween. The piston guide is made of a viscoelatic material.

### BRIEF DESCRIPTION OF THE DRAWINGS

FIG. 1 is a side-sectional view of an air suspension in accordance with an embodiment of the present disclosure;

FIG. 2 is an enlarged view of part “A” of FIG. 1;

FIG. 3 is an enlarged view of part “B” of FIG. 1; and

FIG. 4 is an enlarged view of part “C” of FIG. 1.

### DETAILED DESCRIPTION

Hereinafter, exemplary embodiments of the present disclosure will be described in detail with reference to the accompanying drawings. The following embodiments are given by way of illustration to provide a thorough understanding of the invention to those skilled in the art. Hence, it should be understood that other embodiments will be evident based on the present disclosure, and that system, process or mechanical changes may be made without departing from the scope of the invention. Likewise, it should be noted that the drawings are not to precise scale and some of the dimensions, such as width, length, thickness, and the like, are exaggerated for clarity of description in the drawings. Like elements are denoted by like reference numerals throughout the specification and drawings.

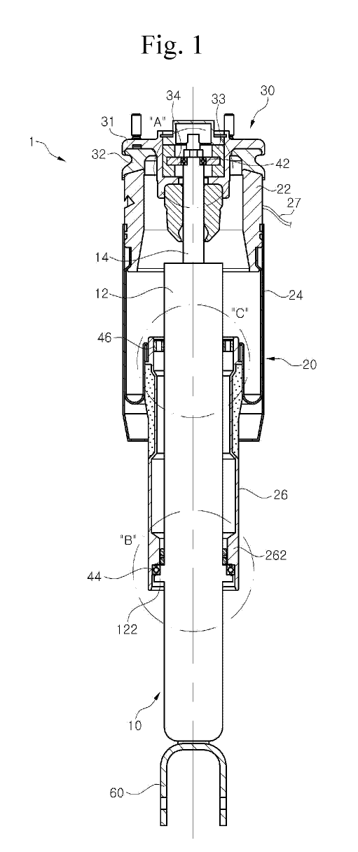

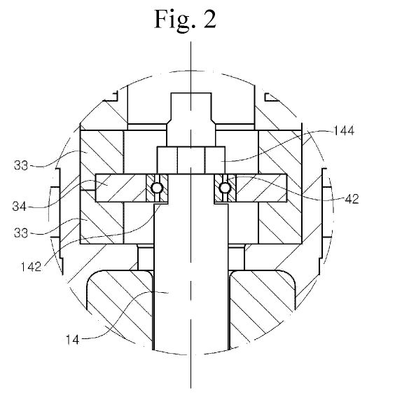

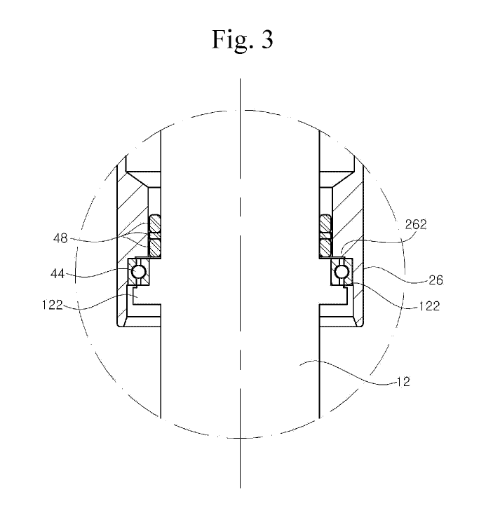

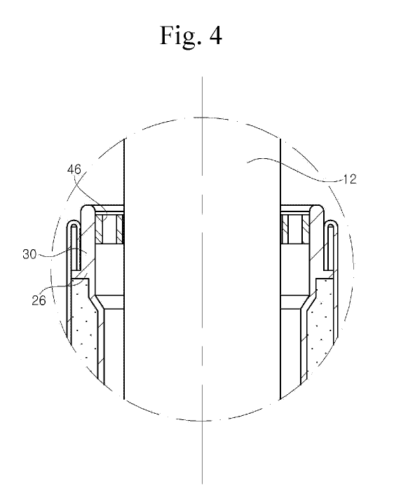

FIG. 1 is a side-sectional view of an air suspension in accordance with an embodiment, FIG. 2 is an enlarged view of part “A” of FIG. 1, FIG. 3 is an enlarged view of part “B” of FIG. 1, and FIG. 4 is an enlarged view of part “C” of FIG. 1.

Referring to FIG. 1, an air suspension 1 according to this embodiment includes a damper 10, an air spring 20 mounted on the damper 10, and an upper mount 30 for connecting the damper 10 and air spring 20 to a vehicle frame (not shown). The damper 10 is provided at a lower side thereof with a bracket 60 which connects the air suspension to an axle or wheel side.

The damper 10 includes a cylinder 12 and a piston rod 14. Although not shown in the drawings, an elongated space filled with an oil is defined in the cylinder 12 and a piston valve (not shown) connected to the piston rod 14 is slidably received in this space. The piston valve reciprocates inside the cylinder 12 by relative movement between the piston rod 14 connected to a vehicle frame side and the cylinder 12 connected to a wheel side, thereby generating a certain damping force in cooperation with the oil. The air spring 20 includes a canister 22, an air sleeve 24, and an air piton 26. The canister 22 surrounds a part of the piston rod 14 extending outside the cylinder 12 and the air piston 26 surrounds a part of the cylinder 12. The canister 22 and the air piston 26 are hermetically connected to each other by the air sleeve 24, so that an air compartment filled with compressed air is formed in the air spring 20. The canister 22 is connected to an air tube 27, which is also connected to the air compartment inside the air spring 20.

The upper mount 30 is mounted on the canister 22 to connect the damper 10 and air spring 20 to the vehicle frame side. The upper mount 30 may include a mount bracket 31, a mount bush 32, a sealing bush 33, and a rod holder 34. The upper mount 30 is connected to the canister 22 via the mount bush 32.

The mount bracket 31 is coupled at an upper portion thereof to the vehicle frame by bolts and the like and has a depressed portion at a center of the mount bracket 31, through which the piston rod 14 passes, so that the sealing bush 33 and the rod holder 34 supported by the sealing bush 33 are placed on the depressed portion. Obviously, various modification of the upper mount 30 may be made and the upper mount 30 is not limited to the details shown in the drawing.

In this embodiment, a first bearing 42 constituted by a thrust bearing is provided to a connecting portion between the upper mount 30 and the piston rod 14, and a second bearing 44 constituted by another thrust bearing is provided to a connecting portion between a lower portion of the air piston 26 and the cylinder 12. Each of the first and second bearings 42, 44 may be constituted by thrust ball bearings. In addition, a piston guide 46 made of a viscoelastic material, for example, urethane, is disposed between the air piston 26 and the cylinder 12.

The first and second bearings 42, 44 are operated to allow relative rotation between the damper 10 and the air spring 20 with respect to torsional rotation applied to the air spring 20 while maintaining the existing fixing structure between the damper 10 and the air spring 20.

The first and second bearings 42, 44 are well adapted to prevent damage of the air sleeve 24 and/or the air tube 27 by counterbalancing rotational moment of a kingpin axis with respect to the torsional rotational of the air spring 20 caused by the variation of the kingpin axis during steering of a 5-link double wishbone type vehicle. FIG. 2 is an enlarged view of the first bearing 42 installed between the upper mount 30 and the piston rod 14, and FIG. 3 is an enlarged view of the second bearing 44 installed between the air piston 26 and the cylinder 12.

The piston guide 46 is provided to reduce the coning angle between an axis of the damper 10 and the air piston 26 during up-down movement and torsional rotation of the suspension 1, and details of the piston guide 46 are shown in FIG. 4.

Referring to FIG. 2, the first bearing 42 is disposed on the piston rod 14 between the rod holder 34 at the upper mount side and the piston rod 14 at the damper side. The rod holder 34 is supported on upper and lower sealing bushes 33, 34 in the depressed portion formed at the center of the mount bracket 31 (see FIG. 1) of the upper mount. The first bearing 42 is supported at one end thereof by a step 142 of the piston rod 14 and supported at the other end thereof by a nut 144 fastened to the piston rod 14. With this arrangement, the first bearing 42 may permit rotation of the canister 22 with respect to the piston rod 14 while being secured to the piston rod 14.

Referring to FIG. 3, the second bearing 44 is tightly fitted between an upper surface of an outer diameter-expansion portion 122 of the cylinder 12 and a lower surface of an inner diameter-expansion portion 262 of the air piston 26. With this arrangement, the second bearing 44 may permit rotation of the air piston 26 with respect to the cylinder 12. Sealing and packing members 48 are provided directly on the second bearing 44 to seal a gap between the cylinder 12 and the air piston 44.

Referring again to FIG. 1, the first and second bearings 42, 44 cooperate with each other to permit relative rotation between the piston rod 14 of the damper 10 and the canister 22 of the air spring 20 and between the cylinder 12 of the damper 10 and the air piston 26 of the air spring 20 at the same time. Accordingly, the first and second bearings 42, 44 may prevent torsional force or torsional moment applied to the air spring 10 from damaging the air sleeve 24, which hermetically connects the canister 22 and the air piston 26, and the air tube 27, which is connected at one end thereof to the canister 22 and at the other end to an external device, for example, a compressor.

Referring to FIG. 4, the piston guide 46 is positioned on an upper end of the air piston 26 so that an outer diameter of the piston guide 46 adjoins an inner diameter of the air piston 26 and an inner diameter of the piston guide 46 adjoins an outer diameter of the cylinder 12. The piston guide 46 may be made of a urethane material and serves to reduce the coning angle (α) between the cylinder 12 and the air piston 26.

As such, according to the embodiment, the air suspension may prevent damage and/or failure of a component of an air spring, such as an air sleeve, by unwanted force or moment, such as a rotational torque, applied to the air spring during vehicle traveling.

The various embodiments described above can be combined to provide further embodiments. Aspects of the embodiments can be modified, if necessary, to employ concepts of the various patents, applications and publications to provide yet further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An air suspension comprising:
a damper including a cylinder and a piston rod;
an air spring in which a canister and an air piston are hermetically connected via an air sleeve;
an upper mount which secures the piston rod and the canister to a vehicle frame;
a first bearing disposed at a connecting portion between the upper mount and the piston rod; and
a second bearing disposed at a connecting portion between the air piston and the cylinder.

2. The air suspension of claim 1, further comprising: a piston guide formed between the air piston and the cylinder to reduce a coning angle therebetween.

3. The air suspension of claim 1, wherein each of the first and second bearings is a thrust bearing.

4. The air suspension of claim 1, wherein the first bearing is disposed on the piston rod between a rod holder at an upper mount side and the piston rod.

5. The air suspension of claim 4, wherein the first bearing is supported at one end thereof by a step of the piston rod and supported at the other end thereof by a fastening portion fastened to the piston rod.

6. The air suspension of claim 1, wherein the second bearing is disposed between an upper surface of an outer diameter-expansion portion of the cylinder and a lower surface of an inner diameter-expansion portion of the air piston.

7. An air suspension for a 5-link double wishbone type vehicle with a kingpin axis comprising:
a damper including a cylinder and a piston rod;
an air spring an comprising air piston;
an upper mount which secures the damper and the air spring to a vehicle frame; and
counterbalancing means disposed between the upper mount and the air spring or the damper for counterbalancing rotational moment of the kingpin axis.

8. The air suspension of claim 7, wherein said counterbalancing means comprises a thrust bearing disposed at a connecting portion between the air piston and the cylinder.

9. The air suspension of claim 7, wherein said counterbalancing means comprises a thrust bearing disposed at a connecting portion between the upper mount and the piston rod.

10. The air suspension of claim 7, wherein said counterbalancing means comprises a first thrust bearing disposed at a connecting portion between the upper mount and the piston rod and a second thrust bearing disposed at a connecting portion between the air piston and the cylinder.

11. The air suspension of claim 7, further comprising: a piston guide formed between the air piston and the cylinder to reduce a coning angle therebetween, the piston guide is made of a viscoelatic material.
